(19) United States
(12) Patent Application Publication
(10) Pub. No.: US 2011/0100183 A1
(43) Pub. Date: May 5, 2011

(54) Table saw blade height and angle adjustment mechanism

(76) Inventor: John Tomaino, Allenhurst, NJ (US)

(21) Appl. No.: 12/590,167

(22) Filed: Nov. 3, 2009

(51) Int. Cl. B23D 45/06; B23D 47/02; B23D 47/08

(52) U.S. Cl. 83/473; 83/477.2; 83/477.1; 83/508.2

(57) ABSTRACT

A mechanism for automatically adjusting the height and angle of a table saw blade is disclosed. The table saw comprises a working surface through which the saw blade protrudes to a certain height. An arbor assembly is connected to the bottom of the working surface of the table saw by means of pivot shoes. The mechanism adjustment disclosed comprises two motors and shafts coupled to the arbor assembly that allows the user to adjust the height and angle of the saw blade independently as required for the dimension of the material to be cut or the desired angle of the cut.

### BACKGROUND OF THE INVENTION

The present invention is directed to the field of table saws. In particular, it is directed to a device that allows a user to automatically adjust the height or angle of the blade in a table saw as required for the particular cut of material needed. The presently available table saws do not have such capabilities. Presently available table saws generally require manual adjustment of the blade angle and height. This normally requires tedious repetitive manual turning of an adjustment handle especially with respect to the blade angle. This process is imprecise and can require substantial effort to get to the precise blade configuration required. The primary objective of the present invention is to solve this problem with a motorized mechanism that allows a user to automatically make the required adjustments.

### SUMMARY OF THE INVENTION

An automatic adjustment assembly for a motorized table saw blade, wherein the table saw comprises a top working surface with a bottom surface through which a rotating saw blade projects to a height and an angle with respect to the top working surface comprising an arbor assembly comprising an arbor on which the rotating saw blade is supported wherein the arbor assembly is attached to the bottom surface of the top working surface by a pair of slotted trunion shoes that are mounted on opposite ends of the arbor assembly, a first adjustment motor coupled to a first shaft which is in turn connected to the arbor assembly for adjusting the height that the saw blade projects from the top working surface whereby rotating the first shaft moves the arbor assembly in a vertical direction resulting in a desired adjustment of the height that the saw blade projects from the top working surface, a second adjustment motor coupled to the second shaft which is in turn connected to the arbor assembly whereby rotating the second shaft varies the angle of the saw blade with respect to the top working surface, and a device for activating the first and second adjustment motors.

### BRIEF DESCRIPTION OF THE DRAWINGS

FIG. 1 is a perspective view illustrating a table saw utilizing the present invention.

FIG. 2 is a view of the table saw without the adjustment wheels installed.

FIG. 3a is a partial front view of the present invention as illustrated in FIG. 1.

FIG. 3b is a partial rear view of the present invention as illustrated in FIG. 1.

FIG. 4 is a perspective view of a component of the present invention.

FIG. 5 is a perspective view of a component of the present invention.

FIG. 6 is a partial side view illustrating angular adjustment of a table saw blade.

FIG. 7 is a partial side view illustrating angular adjustment of a table saw blade.

FIG. 8 is a partial side view illustrating angular adjustment of a table saw blade.

FIG. 9 is a partial side view illustrating angular adjustment of a table saw blade.

FIG. 10 is a partial side view illustrating height adjustment of a table saw blade.

FIG. 11 is a partial side view illustrating height adjustment of a table saw blade.

FIG. 12 is a partial side view illustrating height adjustment of a table saw blade.

FIG. 13 is a cut away view illustrating a table saw arbor assembly with connection points 102 and 104 for the present invention.

### DETAILED DESCRIPTION OF THE PRESENT INVENTION

The present invention will now be described in terms of the presently preferred embodiment thereof, as illustrated in the drawings. It is not intended that the scope of the present invention as set forth in the appended claims should be limited by the description set forth herein.

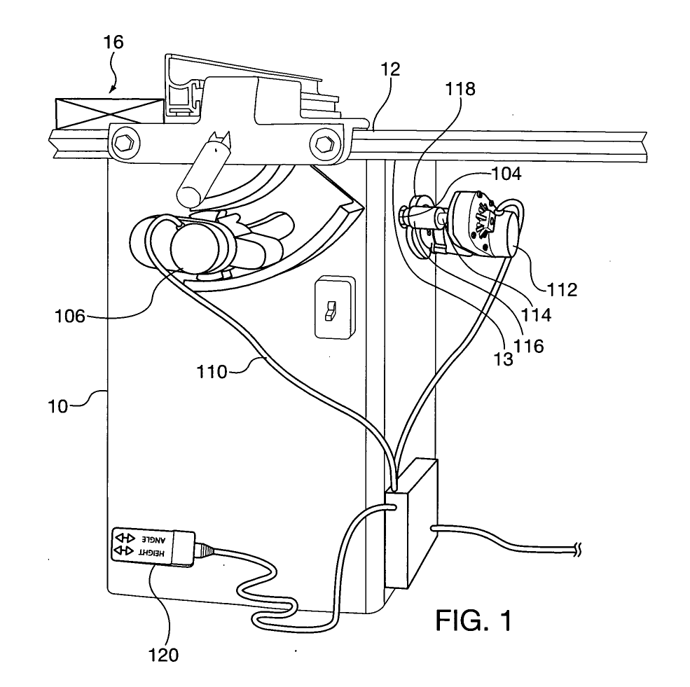

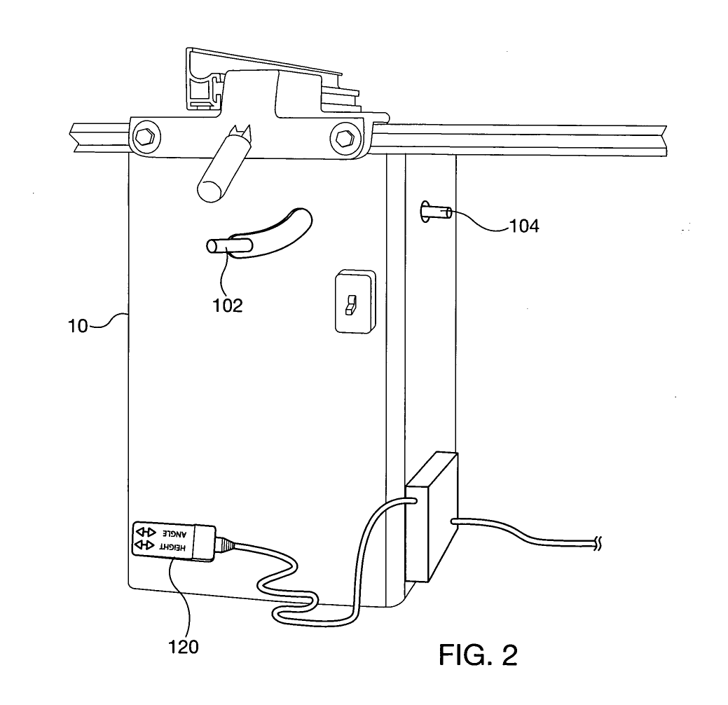

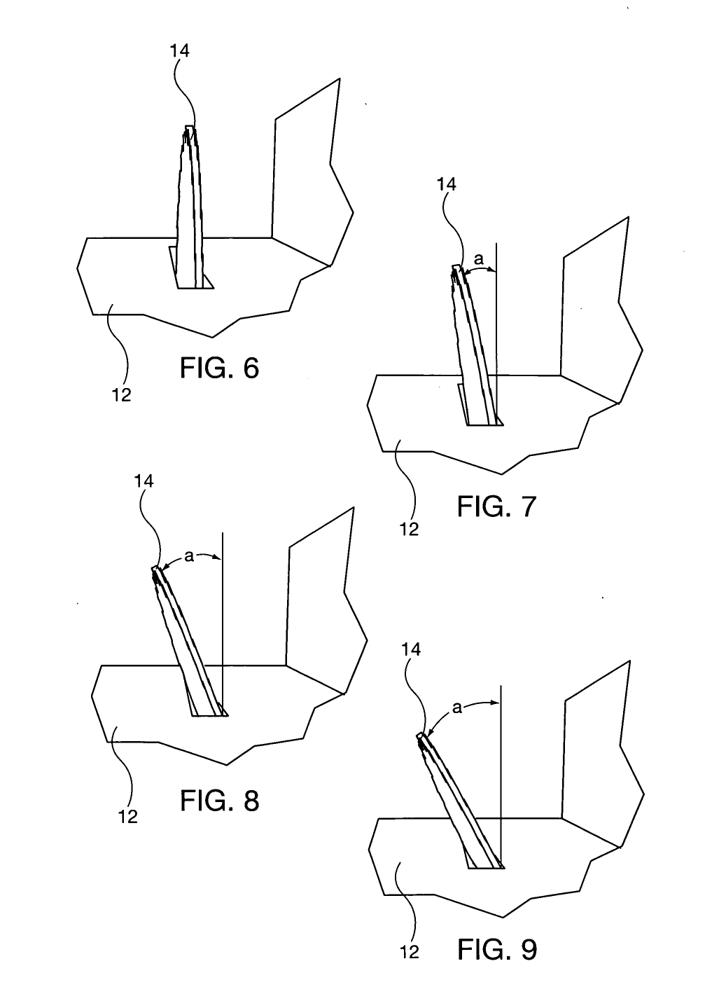

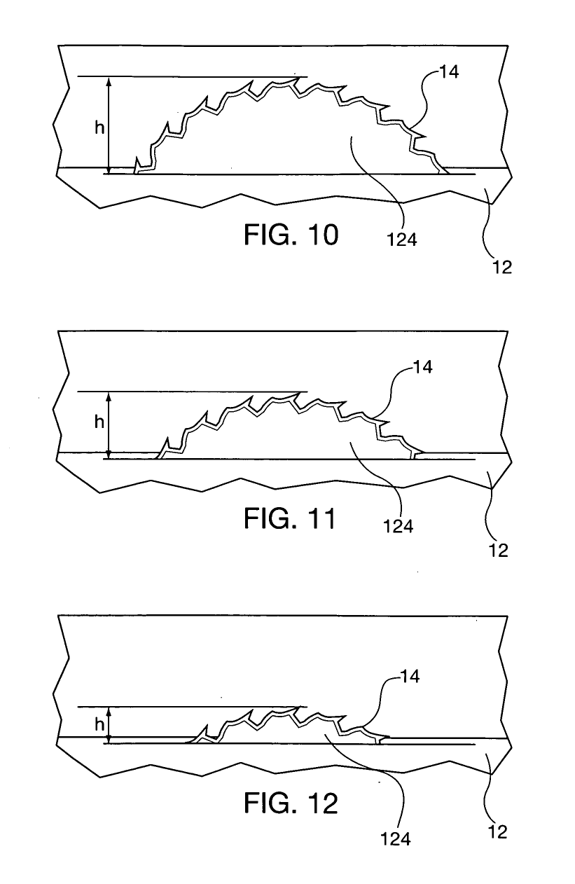

Table saws driven by electric motors are well known devices used by carpenters and other craft persons to cut and trim wood for various applications. FIG. 1 illustrates an available table saw 10 with the present invention mounted thereon. The table saw 10 generally comprises a top working surface 12. A circular rotating saw blade 14 extends upwards by a height ‘h’ from the top working surface 12. The saw blade 14 is illustrated in FIG. 6 as generally perpendicular to the top working surface 12. In practice, a piece of wood (or other material) 16 to be cut or trimmed will be placed on the top working surface 12 and moved into the rotating saw blade 14. Depending upon the thickness of the material to be cut, a user may need to adjust the height ‘h’ of the blade 14 from the top working surface 12 as illustrated in FIGS. 10 to 12. In certain circumstances, the user may also need to vary the angle ‘a’ of the blade 14 from the perpendicular with respect to the top working surface 12 so as to create an angled cut on the piece of wood (or other material) 16. Adjustments of the angle “a” from the perpendicular are illustrated in FIGS. 7 to 9. In available table saws, these two adjustments are normally accomplished by the user manually turning a crank on the front and/or side of the table saw. The present invention is directed to automating the process of blade adjustment.

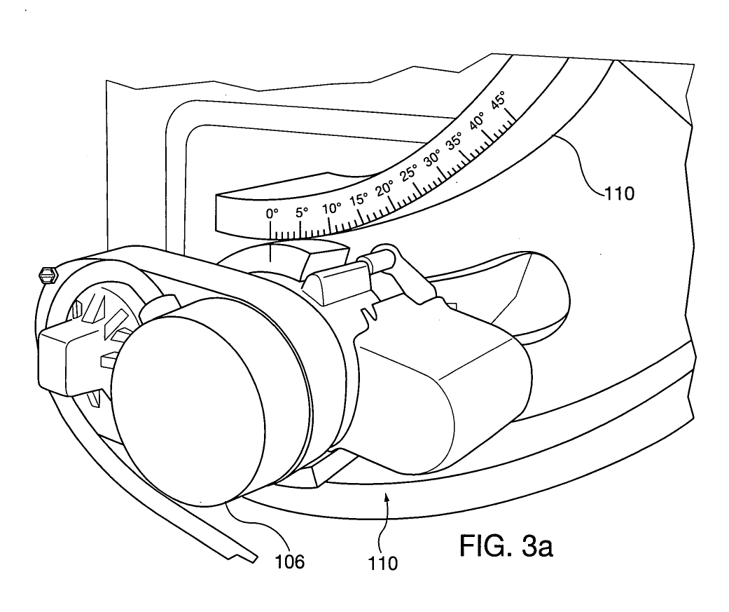

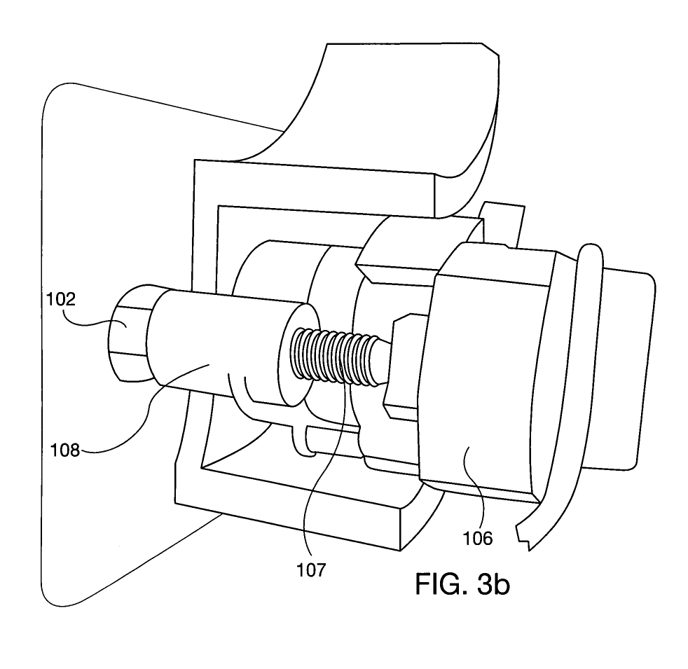

As shown in FIGS. 1, 3a and 3b, a first adjustment motor 106 with an output shaft 107 is mounted by means of a first coupling 108 to a first shaft 102. The first adjustment motor 106 thereby supplies power to the first shaft 102 by means of the coupling 108. A pivot shoe 110 is provided that prevents the first adjustment motor 106 from rotating about its axis when the motor is activated. When the first adjustment motor 106 is activated the first shaft 102 is rotated to raise or lower the saw blade.

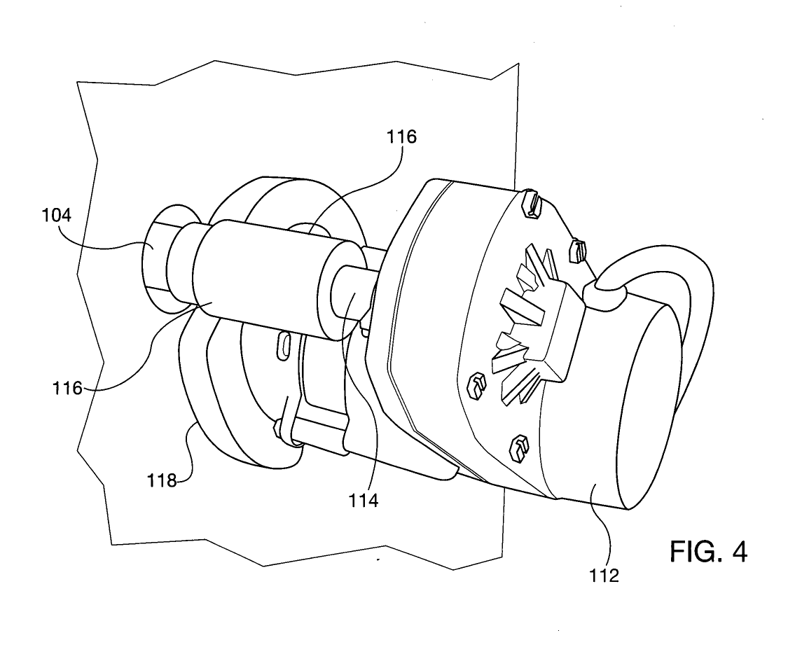

As shown in FIGS. 1 and 4, a second adjustment motor 112 with an output shaft 114 is mounted by means of a second coupling 116 to a second shaft 104. The second adjustment motor 112 thereby supplies power to the second shaft 104 by means of the second coupling 116. An anti-rotation collar 118 is also provided. The anti-rotation collar 118 prevents the second adjustment motor 112 from rotating about its own axis and allows for changes in the angular position of second shaft 104 resulting from the operation of the second adjustment motor 112 and the subsequent change in the angle ‘a’ of the saw blade relative to the top working surface 12. The pivot shoe 110 also allows the assembly comprising the first shaft 102, first adjustment motor 106, and first coupling 108 to pivot when second shaft 104 is rotated by the second adjustment motor 112 (shown in FIGS. 1, 3 and 4) to change the angle ‘a’ of the saw blade relative to the top working surface 12 of the table saw 10. The pivot shoe 110 as shown in FIG. 3a comprises an angular scale which indicates the value of the angle ‘a.’

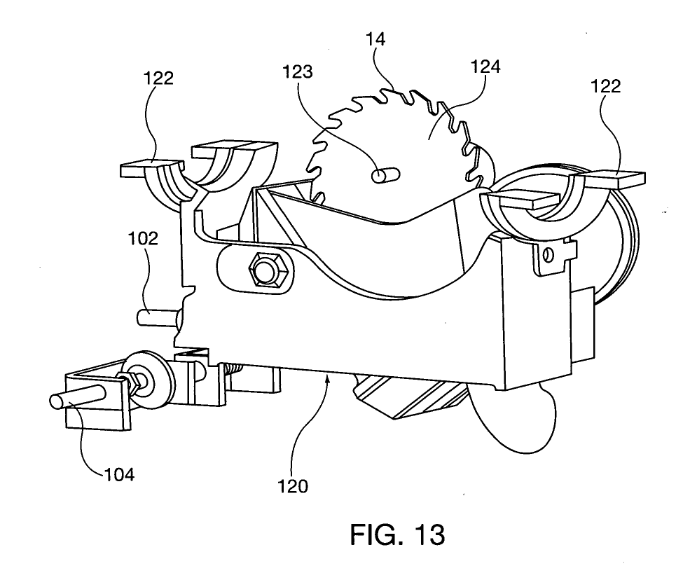

The first and second shafts 102 and 104 are further connected to an arbor assembly 120 as illustrated in FIG. 13. The arbor assembly 120 includes a rotating saw blade 14 which is mounted on an arbor 123. The arbor 123 receives power by means of drive belts connected to the main table saw motor shaft. The arbor assembly 120 is normally attached to the underside 13 of the table saw top working surface 12 with two semi-circular, slotted trunion shoes 122. The trunion shoes 122 thus maintain the arbor assembly 120 suspended from the underside of the table saw working surface 12. The trunion shoes 122 allow the arbor assembly 120 to pivot about a fixed center line which is established by the intersection of the top surface of the table saw and the plane surface of the saw blade 124.

Turning of the shaft 102 normally acts to raise and lower the height ‘h’ of the saw blade between pre-determined height limits. When the shaft 102 is turned, the saw blade 14 and shaft 123 pivot about an internal connection point causing the saw blade 14 to rise above the top working surface 12 and be stabilized at a height which is desired by the user. The saw blade height “h” is limited by the diameter of the saw blade 14 for which the table saw was designed as the slot in the top working surface 12 for the saw blade can only accommodate a particular diameter blade. The shaft 104 is coupled to the shaft of the second adjustment motor 112. Turning of the shaft 104 acts to change the angle ‘a’ of the saw blade relative to the working surface 12 between pre-determined angular limits. Turning of the shaft 104, therefore, moves the arbor assembly 120 relative to the “shoes” 122 and allows the angle ‘a’ of the saw blade to be changed. The saw blade angle ‘a’ normally may be adjusted between 0 and 45 degrees relative to the top working surface 12 of the table saw.

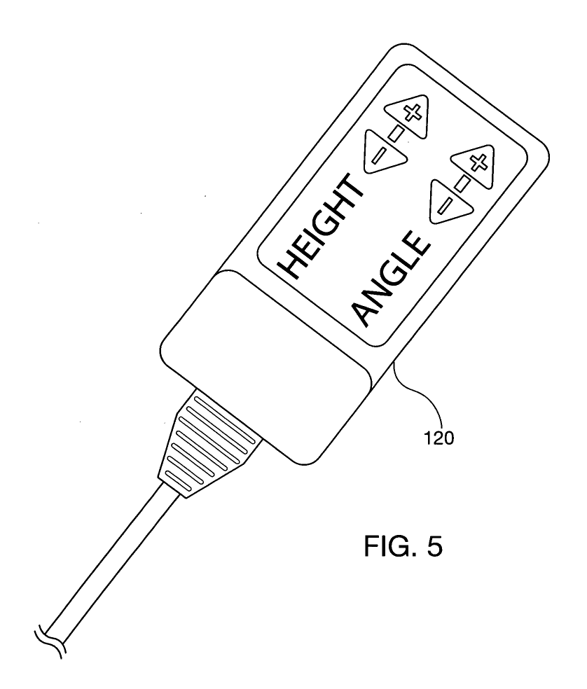

As shown in FIGS. 1 and 5, the first and second adjustment motors 106 and 112 can be activated by use of a hand-held remote control 120 wired to the motors 106 and 112. By pushing the buttons labeled “height” on remote control 120, the first adjustment motor 106 engages the first shaft 102 which moves the height “h” of the blade up and down vertically. By pushing the button labeled ‘angle’ on remote control 120, the second adjustment motor 112 engages the second shaft 104 and can adjust the angle ‘a’ from perpendicular to the top surface 12 to an angle of 45 degrees from the top surface 12.

Those of ordinary skill in the art will recognize that the foregoing merely represents an embodiment of the present invention and that many obvious modifications may be made thereto without departing from the spirit and scope of the present invention as set forth in the appended claim.

What is claimed is:

1) An automatic adjustment assembly for a motorized table saw blade, wherein the table saw comprises a top working surface with a bottom surface through which a rotating saw blade projects to a height and an angle with respect to the top working surface comprising:
a) an arbor assembly comprising an arbor on which the rotating saw blade is supported wherein the arbor assembly is attached to the bottom surface of the top working surface by a pair of slotted trunion shoes that are mounted on opposite ends of the arbor assembly;
b) a first adjustment motor coupled to a first shaft which is in turn connected to the arbor assembly for adjusting the height that the saw blade projects from the top working surface whereby rotating the first shaft moves the arbor assembly in a vertical direction resulting in a desired adjustment of the height that the saw blade projects from the top working surface;
c) a second adjustment motor coupled to the second shaft which is in turn connected to the arbor assembly whereby rotating the second shaft varies the angle of the saw blade with respect to the top working surface; and
d) a device for activating the first and second adjustment motors.

2) A combination motorized table saw and blade adjustment mechanism comprising:
a) a table saw comprising a top working surface with a bottom surface through which a rotating saw blade projects to a height and angle with respect to the top working surface and an arbor assembly comprising an arbor on in which the rotating saw blade is supported wherein the arbor assembly is attached to the bottom surface of the top working surface by a pair of slotted shoes that are mounted on opposite ends of the arbor assembly;
b) a first motorized adjustment assembly to adjust the height of the saw blade;
c) a second motorized adjustment assembly to adjust the angle of the saw blade; and
d) A device for activating the first and second motorized adjustment assemblies.

3) The combination of claim 2 wherein:
a) the first motorized adjustment assembly comprises a first adjustment motor coupled to a first shaft which is in turn connected to the arbor assembly for adjusting the height that the saw blade projects from the top working surface whereby rotating the first shaft moves the arbor assembly in a vertical direction resulting in a desired adjustment of the height that the saw blade projects from the top working surface; and
b) the second motorized adjustment assembly comprises a second adjustment motor coupled to the second shaft which is in turn connected to a second shaft on the arbor assembly whereby rotating the second shaft varies the angle of the saw blade with respect to the top working surface
